(19) United States
(12) Patent Application Publication
(10) Pub. No.: US 2008/0077932 A1
(43) Pub. Date: Mar. 27, 2008

(54) Mechanism for Automatically Managing the Resource Consumption of Transactional Workloads

(75) Inventors: Carmen Ruppach, Sinddlingen (DE); Robert Vaupel, Rottenburg (DE); Stefan Wirag, Sindelingen (DE)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/856,855

(22) Filed: Sep. 18, 2007

(30) Foreign Application Priority Data
Sep. 25, 2006 (EP) 06121176.9

(51) Int. Cl. G06F 9/46

(52) U.S. Cl. 718/105

(57) ABSTRACT

The present invention relates to a method of workload management in a computer system (100), in which units of work (152) are organized into service classes (121), to which a certain amount of system resources (140) is provided, and in which a number of service class periods (122) is associated to each service class (121), characterized in that the workload behavior within at least one present service class period (122) is determined, and the number of available service class periods (122) is automatically adjusted based on the determined workload behaviour.

A workload manager is a software component that manages system resources of a computer system that are to be made available to each executing work item based on performance criteria that define, implicitly or explicitly, relative priorities between competing work items. Performance criteria can be for example user defined goals. In other words, workload management adjusts system resources to incoming work based on goal definitions which reflect workload demands and user expectations. One special focus is on transactional workloads which usually represent important and short running end user requests which need to be completed in a short time period.

During workload management units of work that are managed by an operating system are organized into distinct classes (referred to as service classes or resource classes). In other words, each work unit is associated with a service class, for example, online transaction, high priority batch, low priority batch, etc. To each service class a certain amount of system resources is provided.

The use of the terms work, work unit, unit of work, business unit of work, and transaction in this context are interchangeable, and are used to represent useful user-defined processing on a computer system. The particular term applied by users of the computer system depends on the system type, common terms include job, task, process, thread etc.

Each service class carries with it a set of parameters which indicate to the workload manager the performance criteria of the associated work units. Thus, the workload manager can adjust the resources being allocated to work units of that service class, if the workload manager notes that the resources being allocated to work units of a given service class are repeatedly failing to enable work units of that service class to meet their performance criteria. For example, resources are reassigned from a donor service class to a receiver service class, if the improvement in performance of the receiver service class resulting from such reassignment exceeds the degradation in performance of the donor service class. In short, reassignment takes place if there is a net positive effect in performance as determined by predefined performance criteria. The assignment of resources is determined not only by its effect on the work units to which the resources are reassigned, but also by its effect on the work units from which they are taken.

Each service class is associated with a performance goal and an importance level. The importance level of a service class defines the way the computer system is dealing with the work in that service class if the system is under contention so that the performance goal of some service classes can not be fulfilled. In this case, the computer system will neglect the performance goal of service classes with low importance level.

Work which is associated with a service class consumes computer system resources. Problems arise when the work is not homogenous and shows a high variation in its execution time and resource consumption, for example if the time to execute some few requests is well above average and at the same time consuming too many system resources. As a consequence other work running on the system is negatively impacted from these long running high resource consuming work.

In some workload management environments, such as the IBM z/OS workload manager, a number of periods can be associated to each service class, thus defining a way how the work behaves when it processes longer than expected. A user request is then switched from one service class period to another service class period when it consumes more system resources than allowed for the current service class period. The lower service class periods usually run at lower importance and goal levels in order to mitigate the impact of the long running requests to other workloads sharing the same computer system resources. In other words, by defining further service periods it is possible to reduce the goals for long running and high resource consuming work.

A major problem is to define service class periods in order to spread the work appropriately, to minimize its impact on other workloads, and to assure that the important requests complete fast enough. From the prior art it is known, that a fixed set of periods is predefined by the management component within the operating system or that service class periods are defined and adapted manually by a computer administrator or another person. In case of a fixed set of periods has the problem that the periods may not optimally fit the workload characteristics and therefore the work is not optimally spread between periods. The manual adaptation of periods requires a constant and expensive supervision of the computer system and analysis of system performance data.

It is an object of the present invention to provide a workload management technique, which is less complex and leads to a better performance of computing.

This object is achieved according to the invention by a method of workload management in a computer system,

in which units of work are organized into service classes, to which a certain amount of system resources is provided, and

in which a number of service class periods is associated to each service class,

characterized in that

the workload behavior within at least one present service class period is determined, and

the number of available service class periods is automatically adjusted based on the determined workload behavior.

This object is achieved according to the invention by a data processing program for execution in a computer comprising software code portions for performing a method according to the present invention when said program is run on said computer.

This object is achieved according to the invention by a computer program product stored on a computer usable medium, comprising computer readable program means for causing a computer to perform a method according to the present invention when said program is run on said computer.

This object is achieved according to the invention by a workload manager for a computer system,

in which units of work are organized into service classes, to which a certain amount of system resources is provided, and

in which a number of service class periods is associated to each service class,

characterized in that it comprises

means for determining the workload behavior within a present service class period, and

means for automatically adjusting the number of available service class periods based on the determined workload behavior.

A basic idea of the present invention is to autonomically breakdown service classes into multiple service class periods. With the present invention, no manual definition of service class periods is necessary. The present solution is less complex as known solutions from the prior art and leads to a better performance of computing without the need for a constant and expensive supervision of the computer system and analysis of system performance data.

The invention describes a method to autonomically control the resource consumption of transactional workloads on an information handling system in order to improve system throughput. The method assumes that service classes are defined with an importance and a goal to control the resource consumption of transactional workloads. Each of these service classes is initially associated with one service class period. Further, a workload manager exists, which assigns resources to that service class periods so that the work running in the service class fulfills the specified goal. If the system is under contention, it is assumed that service class periods with a higher importance will obtain a preferred and therefore better access to the resources.

The present invention is based on the assumption that transaction characteristics like response times and resource consumption provide information about the optimal distribution of transactions in service class periods. The history of such information is used to autonomically determine the optimal number of service class periods and their durations to improve the overall system throughput.

The new approach is based on the assumption that the workload management system understands when a user request starts and when it ends. This is usually the case for instrumented workloads which inform the workload management system about incoming and ending transactions. Based on this information the workload management system learns the characteristics of work requests running in a service class. The workload management system identifies how long transactions run in the system and how much resources they consume. Based on this information the workload manager decides how many resources are required to complete a majority of short running transactions and what the costs, i.e. the resource consumptions, for long running transactions in the system are. If these costs are too high, the workload manager moves the long running transactions in a new service class period with a lower performance goal.

The present invention relates to a technique which autonomically creates service class periods. If service class periods are created as described, the resource consumption of transactional workloads can be managed in a way that short running transactions can complete fast and long running transactions will be degraded in order not to harm other work and the short running transactions in the system. In other words, the present invention discusses a mechanism which automatically creates service periods and which automatically correlates long running work with lower service goals. The mechanism autonomically creates such service periods and deletes them if they are not needed anymore. This approach can be used for goal oriented as well as resource oriented workload management systems. The present invention further relates to a technique, which not only creates and deletes service class periods, but automatically adjusts the characteristics of service class periods based on the determined workload behavior. In particular the importance level and/or the performance goal of each created service class period is set according to the workload characteristics.

The major advantage of this new technique is that no manual service class period configuration is required and that the workload management system can react instantaneously on actual workload behavior. For service classes with a high load the learning period will be short and the adjustment will immediately improve the throughput of the system. As a result the installation has lower administrative costs and a more autonomic environment.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

An embodiment of the present invention will now be described with reference to the accompanying drawings, in which

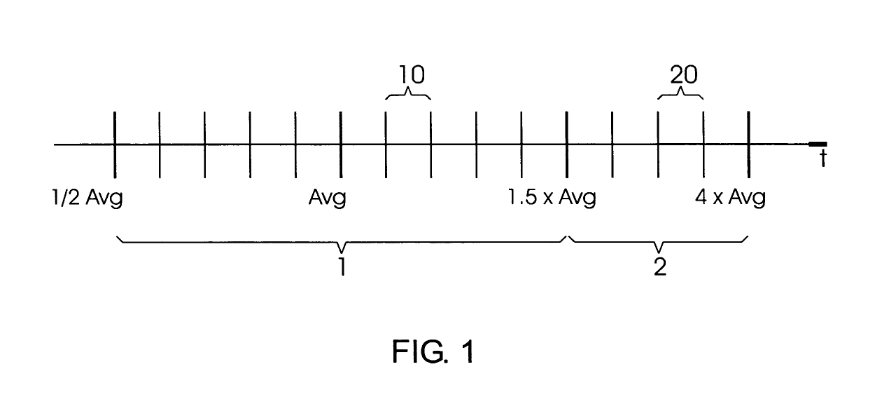

FIG. 1 illustrates a separation of the response time in buckets,

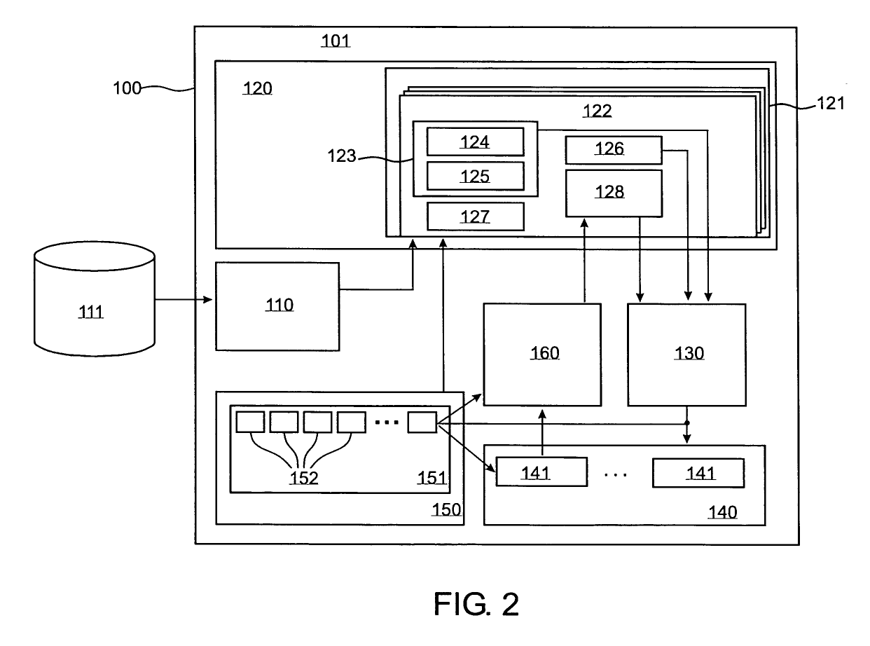

FIG. 2 illustrates a computer system with a workload manager,

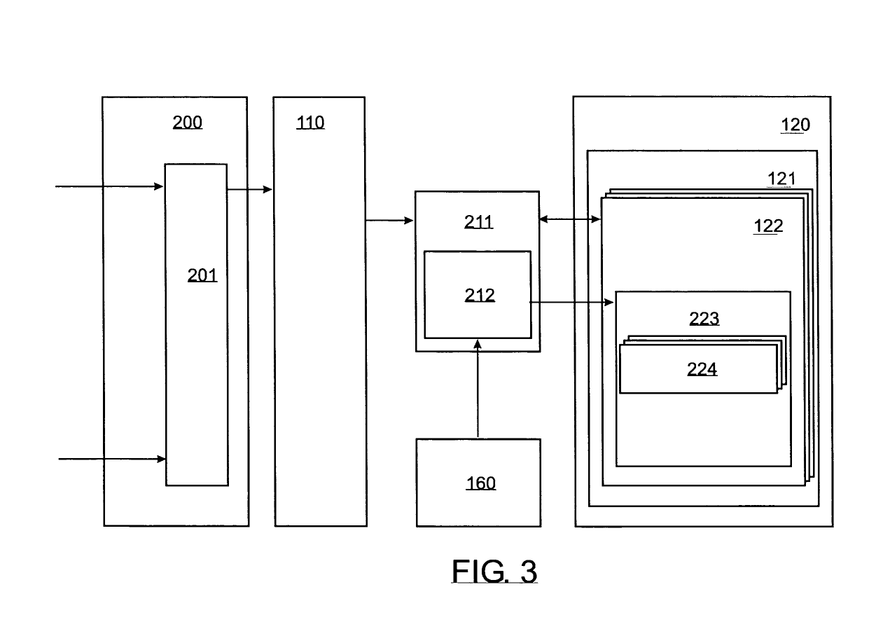

FIG. 3 illustrates the interaction between a subsystem or application and a workload manager,

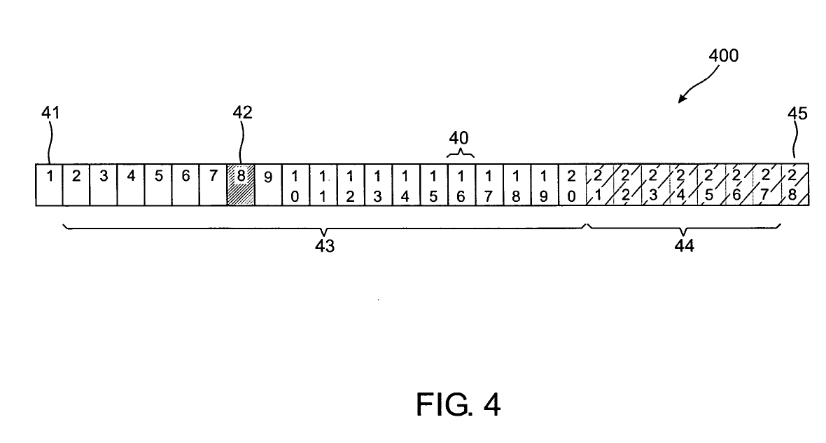

FIG. 4 illustrates a layout of a response time distribution,

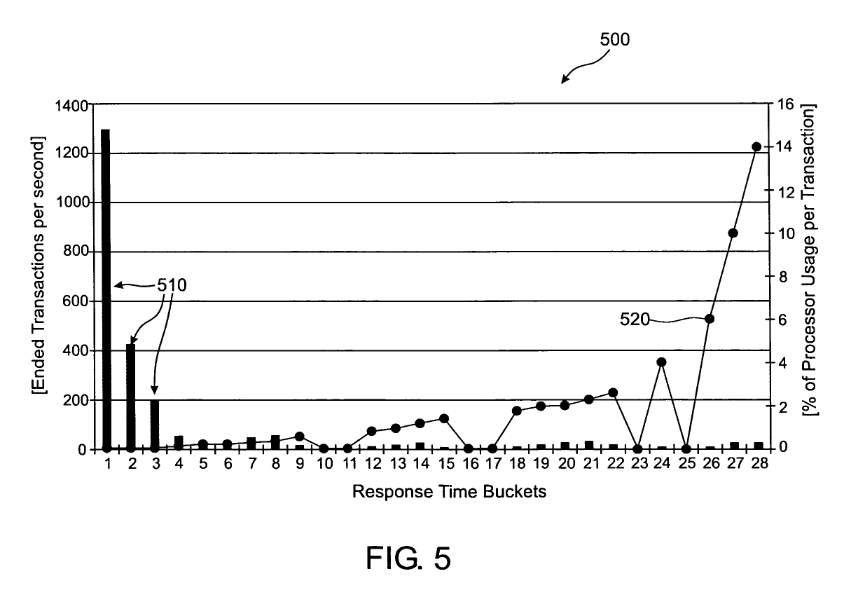

FIG. 5 illustrates a CPU consumption per transaction in response time distribution bucket,

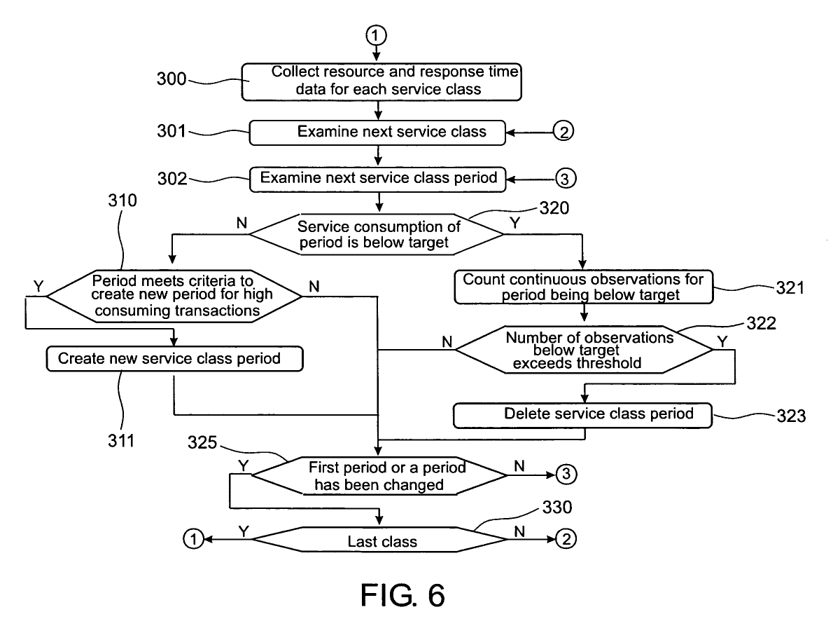

FIG. 6 illustrates a flowchart of the method according to the present invention, and

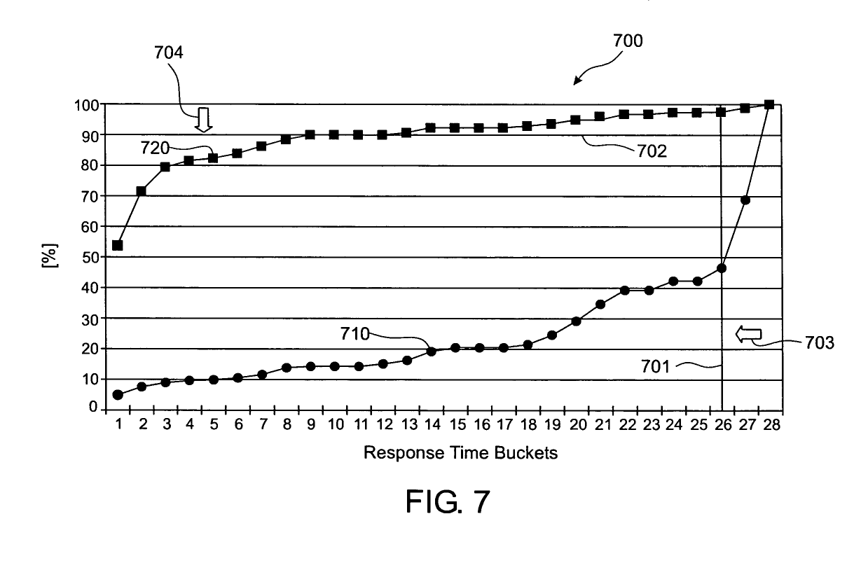

FIG. 7 illustrates CPU consumption and total ended transactions for a service class period.

First, the basic principles of the method according to the present invention are explained. The present invention is based upon the assumption that the installation, i.e. the combined hardware and software adapted to implement the present invention, defines service classes with an importance and a goal, as explained below in more detail. Each of these service classes is initially associated with one service class period. A workload manager assigns resources to these service class periods in a way that the work running in the service class fulfills the specified goal. If the system is under contention, it is assumed that service class periods with a higher importance will obtain the resources first. The breakdown of the service class into multiple service class periods is done autonomically via a mechanism, which can be separated into the following steps which are executed periodically by means of the workload manager.

Step 1: Determining the workload behavior. For this step the workload manager must know the resource consumption of the work requests running in a service class.

Step 2: Deciding when to create a new service class period.

Step 3: Defining the new service class period. When the new service class period is created a performance goal is assigned to it and a service class period switch condition is assigned to the previous service class period. Then the mechanism starts the next cycle to monitor the new service class period.

Consequently the mechanism allows to delete a service class period (Step 4) if an insufficient amount of work is associated with this service class period.

In order to understand the resource consumption of the work requests running in a service class period, the workload manager is adapted to capture the begin and end of work requests running in the service class. This is usually possible for all instrumented applications. Such instrumented applications are possible e.g. through the Application Response Measurement (ARM) standard of the Open Group or by native instrumentations of operating systems such as enclave services on z/OS. As a result the workload manager captures the amount of requests being executed by the processes of the service class and is able to measure the resource consumption of such requests.

For understanding how the workload behaves it is necessary to distinguish long running from short running transactions. For such purposes the workload manager must categorize the transactions by their execution time. As a starting point the workload manager uses the average transaction completion time and then creates a set of buckets around it to capture the resource consumption of the transactions. Each bucket represents a time period in which a transaction has ended or is running in. The resource consumption of these buckets creates a distribution which allows the workload manager to determine at which point a new service class period is desirable.

FIG. 1 shows a possible separation of the response time “t” of a workload in response time buckets 10, 20. After determining an average response time value “Avg” a first set 1 of equidistant response time buckets 10 is created by the workload manager around this average value “Avg” and a second set 2 of non equidistant buckets 20 is created to capture the outliers. Preferably the distribution changes over time to recognize that the workload behavior changes. The approach allows to create a response time distribution for work which is managed towards a throughput oriented goal.

Another more simple starting point for such a distribution is given when the service class is managed towards a response time goal. In such cases the response time value is used as the mid point of the distribution and the response time distribution is created based on this value.

After defining the response time distribution it is possible to capture the resource consumption for the completed transactions. In addition, it is possible to always factor the resource consumption of in-flight transactions in the distribution. In-flight transactions are transactions that have not been ended. In order to keep a continuous picture the in-flight transactions are captured periodically and the distribution is maintained over several time periods. Previous time periods are analyzed in order to understand the momentary workload behavior and that sufficient historical data are available in order to make a decision by means of the workload manager.

After having explained the basic principles of the invention, an example of a computer system 100 executing the method according to the invention will now be illustrated. The computer system 100 as shown in FIG. 2 is executing a workload and is controlled by an operating system 101. In the embodiment shown the IBM z/OS operating system is used. Except for the enhancements relating to the present invention, the computer system 100 is the one disclosed in application Ser. No. U.S. Ser. No. 08/383,168.

Although not shown in FIG. 2, computer system 100 may be one of a plurality of interconnected systems that are similarly managed and make up a sysplex cluster. The general server management concept is described in U.S. Pat. No. 5,974,462 except for the enhancements relating to the present invention.

In the present embodiment a workload manager 110 is an integral component of the operating system 101. However, the workload manager 110 can also be implemented as an external unit, connected to and cooperating with the operating system 101. The operating system 101 with its workload manager 110 is adapted to perform the method steps of the present invention.

The workload manager 110 is operating based on a service definition 111 which is defined by the installation, e.g. by a user. The service definition 111 is read by the workload manager 110 during system activation from an external dataset provided outside the operating system 101. The service definition 111 contains details on service classes 121 and service goals 123. The service classes 121 are organized in a service class table 120 which is the internal representation of the data basis for the decisions made by the workload manager 110.

Each service class 121 is divided into service class periods 122. Each service class period 122 is associated with a service goal 123. A service goal 123 can either be a goal based on a response time 124 or a throughput oriented goal based on an execution velocity 125. Such a throughput oriented goal is named execution velocity goal. The response time 124 is the time in which units of work should end on average or in which a defined percentage of unit of works should end. The execution velocity 125 corresponds to an acceptable delay work is allowed to encounter when it moves through the system.

Each service class period 122 is further associated with an importance level 126. According to the importance level 126 the workload manager 110 decides which service periods 122 need preferred treatment if the system resources become short.

In order to assure that work can only consume a certain amount of resources each service class period 122 is associated with a duration 127. The duration 127 is defined in consumable resource units depending on the kind of operating system in use. In case an IBM z/OS is used, such resource units are named service units which allow to normalize the processor, storage and I/O consumption to consumable resource units. If a service class 121 comprises only one service class period 122, the duration definition is omitted and thus infinite. The same applies for the last period of the service class 121.

The service period 122 further comprises sample and management data 128 which is used during runtime of the computer system 100 to determine the goal achievement and switch of units of work from service class period to service class period.

Business units of work 152 are identified by the operating system users 150, i.e. by applications or subsystems 151 executed in the computer system 100 and controlled by the operating system. Subsystems 151 use a set of predefined interfaces to the workload manager 110 to associate a new unit of work 152 with a service class 121, as explained in a more detailed way below.

The workload manager 110 consistently collects data about the operating system resources 140. In context of the present invention the most interesting data are the resources 141 of the central processing unit (CPU). The workload manager 110 is complemented by a data sampler 160 which collects the resource data and thus generates the sample and management data 128 of the service class periods.

The workload manager 110 uses the collected sample and management data 128 to reach decisions and influences the access of the work to the resources, i.e. controls the access of work units 152 to the operating system resources 140. These steps of deciding about the access of work units 152 are carried out in a goal management device 130, which complements the workload manager 110. Data sampler 160 and goal management device 130 can be implemented as part of the workload manager 110 or as external units closely cooperating with the workload manager 110.

FIG. 3 describes the interaction between a subsystem, e.g. CICS, IMS, Websphere, etc. or application 200 and the workload manager 110 of the operating system 101. When a new work request arrives, it is executed by a process or thread 201 in the application 200. In a first step the workload manager 110 is informed that a new unit of work 152 has arrived. For this purpose the workload manager 110 defines a set of application interfaces, which are implemented as part of the workload manager 110. These application interfaces are adapted to provide the workload manager 110 with the information about the arriving of a new work request. The application interfaces are further adapted to provide attributes to the work request which allows the workload manager 110 to classify the work request, to determine which thread is currently working on the work request and to inform the workload manager 110 when the work request has ended.

The workload manager 110 then creates an internal representation 211 of the unit of work 152. This internal representation 211 is sometimes referred to as an enclave. Through the classification process the unit of work 152 is associated with a service class 121. During execution the unit of work is further more associated with a service class period 122 in order to assure that it is managed towards current goals.

The data sampler 160 continuously collects status data 212 which is associated with the unit of work 152 and which is summarized across all units of work 152 associated with the same service class period 122 in a status data bucket 223 of the service class period 122, see below.

Besides other resource consumption data a response time distribution 224 is provided for service periods 122 with a response time goal. The response time distribution 224 is dynamically created by means of the workload manager 110 based on the response time goal for the service class period 122 as a starting point.

FIG. 4 shows the general layout of the response time distribution 400. The illustrated implementation comprises 28 buckets 40. The buckets 40 are created by means of the workload manager 110 by the following calculation:

$$bucket number = \{ \begin{matrix}1 & if rt \leq 0.5 goal \\ 1 + \frac{rt - 0.5 goal}{bucket width} & if rt > 0.5 goal ⋂ rt \leq 2 goal \\ 21 + \frac{rt - 2 goal}{0.5 goal} & if rt > 2 goal ⋂ rt \leq 5 goal \\ 28 & if rt > 5 goal\end{matrix} \\ with \\ bucket width = \frac{1.5 goal}{20}$$

In other words, the bucket number is “1” if the measured response time (rt) of ended transaction is less or equals half the goal value for transactions in the service class and the bucket number is “28” if the measured response time (rt) of ended transaction is larger than the fivefold goal value for transactions in the service class.

The very first bucket 41 is thus related to very short running transactions. The eight bucket 42 corresponds to the average response time. Transactions ending around the goal value correspond to the range 43 between the second and the twentieth bucket. Long running transactions correspond to a range 44 between the buckets 21 and 27. The last bucket 45 is related to very long running transactions.

It should be noted that this distribution 400 is just an example and that any similar distribution can be used which classifies data around an expected value.

While the existing distribution, as shown in FIG. 4, only collects the number of ending transactions and in-flight transactions for service class periods 122, it is possible to modify by means of the workload manager 110 the distribution 400 in the following way:

For all types of goal oriented service class periods 122 a response time distribution is generated as long as the service class period 122 is associated with representations 211 of units of work 152. Because the workload manager 110 knows this relationship it is also always possible to measure the response time “rt” for such service class periods 122 even if an execution velocity goal has been defined.

For service class periods 122 with execution velocity goals the average response time of ended transactions during e.g. a thirty minute time period is used. This value is set by means of the workload manager 110 equivalent to the response time goal value in order to create a response time distribution. The value is adjusted periodically and the distribution adjusted accordingly by means of the workload manager 110.

For service periods with a response time goal the response time goal is continuously used to create the response time distribution. CPU consumption is added to the distribution so that the number of ended transactions and the CPU resource consumption is tracked.

FIG. 5 depicts the CPU consumption per transaction in response time distribution bucket. In other words, a typical response time distribution 500 consisting of 28 buckets is illustrated, with CPU consumption being additionally shown. For the present example it is not important which bucket represents the average response time. It is only important that the buckets on the left side of the distribution (buckets No. 1, 2, 3, . . . ) represent all short running transactions and the buckets on the right side of the distribution (buckets No. . . . , 26, 27, 28) represent the long running transactions.

The average CPU consumption of a transaction ending or still running in a bucket is illustrated in FIG. 5 exemplary in order to show that the resource consumption for long running transactions is dramatically higher than the resource consumption for short running transactions. The chart illustrates the number of ended transactions 510 and the CPU consumption per transaction 520. In this embodiment the CPU consumption is used to illustrate the total resource consumption. However, the method is not limited to CPU consumption. Other types of resource consumption may be used as well. As illustrated in FIG. 5 an average transaction in the first bucket No. 1 on the left side uses less than 0.1% of a CPU while a transaction in the last bucket No. 28 on the right side requires about 14% of a CPU. Especially in cases where a service class period has a high importance and a stringent goal to meet the expectations for online transactional workloads, such variation can harm the overall throughput of the computer system 100. The idea of the invention is now to identify such variation and to determine whether splitting the service period is beneficial for the system throughput. In other words, the idea is to redefine a service class period so that the average resource consumption is uniform across the buckets. While most transactions end in the first buckets (No. 1, 2, 3, . . . ) the resource consumption of the first buckets is a good indication of how much influence the work requests have on other work in the computer system 100.

If a new service class period shall be created, it is according to the invention determined, which transactions should be moved into the new service class period.

FIG. 6 illustrates the progression of the proposed algorithm executed by the workload manager 110. In a first step 300 resource and response time data is collected for each service class. Periodical data collection and summarization of the data for each service class period is the basis for the algorithm used. A data collection period is herein after referred to as observation. Data collection and summarization is carried out by the workload manager 110. After data is collected, the response time/CPU consumption distributions for each service class period are updated.

Subsequently all service classes are periodically, in arbitrary intervals, examined whether an service class period associated to this class should be split or whether associated service class periods could be deleted again (step 301). For that purpose all service class periods of a service class are examined one after the other (step 302). During execution of the illustrated workflow all service classes and all service class periods are examined. The test for each service class always starts with the last period of the service class, i.e. the service class period with the longest running transactions.

The proposed algorithm incorporates a reversed or housekeeping function which allows to delete previously created service class periods. Therefore, in the next step 320 it is determined, if the resource consumption of work units associated with the examined service class period becomes too small, i.e. the resource consumption of said period is below a defined target value. The exact criterion to identify low resource consumption is discussed in more detail below. Step 320 is not executed for the first service class period of a service class because the first period is defined by the user and is therefore never deleted. For the first service class period of a service class, after step 320 immediately follows step 310.

Work may have time periods of high activity and those of low activity. Therefore just analyzing the current resource consumption of a service class period is not sufficient. Thus, if the test in step 320 reveals, that the service class periods is not justified, the service class period is not immediately combined with the preceding service class period. Instead the workload manager 110 counts the number of continuous observations (i.e. data collection periods) in which the resource consumption of the service class period has been below the defined target value (step 321). This target value can be set by the installation, e.g. by the user or automatically by the workload manager 110, to ensure that during a certain time period service class periods with low resource consumption can exist.

In a next step 322 subsequent to step 321 it is determined, if the number of observations exceed a threshold. If this is the case, the examined service class period is deleted in step 323 and the collected data and all units of work of the deleted service class period are associated with the preceding service class period.

In case a criterion is not met in step 322 the examination of the current service class period ends and the algorithm proceeds with step 325.

In step 325 it is determined, whether the service class period under examination is the first period of the service class or if a period has been changed (i.e. deleted or created) for this service class in this cycle. If the first criterion is fulfilled, all periods of the examined service class have been investigated in this cycle. If the second criterion is fulfilled, the periods of the service class have been changed in this cycle and the remaining periods of the examined service class are not examined because a creation or deletion of a service class period may have a major impact on all other service class periods of the service class and the system needs time to reflect these changes in the collected data to be able to decide whether another change is reasonable. If none of these criteria is fulfilled, the algorithm continues with the examination of the next service class period of the examined service class (step 302). If one of those criteria is fulfilled, the algorithm ends for the examined service class and it is determined in step 330 if all service classes have been examined in this cycle. If this is not the case, the algorithm continues with processing the next service class with step 301 or if all service classes have been processed, the algorithm ends for this cycle and continues with data collection with step 300 until the next tests are performed.

If criterion 320 is not fulfilled for the examined service class, it is determined in a next step 310, if said service class period contains long running and high CPU resource consuming transactions.

If a service class period contains long running and high CPU resource consuming transactions, said service class becomes a subject for a service class period split. In step 310 it is tested whether the service class period meets the criteria for a split. The criterion is discussed in more detail below. If it meets the criteria, a new service class period is created in step 311. This is also discussed in more detail below.

If a service class period does not contain long running and high CPU resource consuming transactions, i.e. if the criterion of step 310 is not met, the algorithm continues with the next service class period of the currently examined service class or the next service class, dependent on the result of step 325 and 330 (see above).

The period split criterion used in step 310 determines if the service period has non-uniform resource consumption. The service class period has non-uniform resource consumption, if a so-called split bucket can be identified within the response time buckets of the service class period. The split bucket is the bucket with the lowest bucket number in which the CPU consumption is becoming non-uniform compared with all the preceding buckets. Two criteria are applied to determine if such a split bucket exists: a CPU consumption criterion and a lowest split bucket criterion. The CPU consumption criterion determines if an individual response time bucket has a non-uniform CPU consumption. The lowest split bucket criterion ensures that a reasonable amount of transactions will still be ending in the service period if it would be split. The lowest split bucket criterion determines the bucket, called lowest split bucket, with the lowest bucket number that is allowed to become a split bucket. If a lowest split bucket has been identified according to the lowest split bucket criterion, a potential split bucket can be determined as follows. The buckets are traversed in direction of decreasing bucket numbers. For each bucket, the CPU consumption criterion is verified. If the CPU consumption criterion is fulfilled, the bucket is considered as split bucket candidate. The traversal of buckets stops at the bucket that is associated with twice the goal value. If no split bucket candidate is found, the period split criterion is not met and step 325 is carried out. Otherwise, the period split criterion is met and the split bucket is equal to the last split bucket candidate found if its bucket number is greater than the lowest split bucket number or the split bucket is equal to the lowest split bucket if its bucket number is lower or equal to the last split bucket candidate found.

Different CPU consumption criteria and lowest split bucket criteria can be defined. However, the objective is always to identify a split bucket in a way that a split of the service period at this bucket leads to a uniform average resource consumption across the buckets of the split service period. In the following, some examples of such criteria are given. Those example criteria rely on the accumulated CPU consumption per bucket and the total ended transactions per bucket.

FIG. 7 depicts a chart 700 illustrating the accumulated CPU consumption 710 and the number of total ended transactions 720 in buckets No. 1 to No. 28 for a single service class period. The vertical line 701 in FIG. 7 represents the determined split bucket. The horizontal line 702 represents the lowest split bucket criterion. Arrows 703 and 704 illustrate the directions in which the data analysis is carried out.

The CPU consumption criteria can be determined for example in the following way: If the increase of the resource consumption between the investigated bucket and the succeeding bucket and the resource consumption increase between the preceding bucket and the investigated bucket exceeds an installation defined ratio threshold, e.g. three, the investigated bucket is a split bucket candidate. Using this method, the last split bucket candidate in FIG. 7 would be the 26th bucket.

Alternatively, the CPU consumption criteria can be determined for example in the following way: The accumulated resource consumption of the first N buckets, e.g. N=4, is considered as the uniform resource consumption. The investigated bucket is a split bucket candidate if it exceeds the uniform resource consumption by a threshold factor, e.g. factor two. Using this method, the last split bucket candidate in FIG. 7 would be the 15th bucket.

The lowest split bucket criteria can be determined for example in the following way: The lowest split bucket is the bucket where a certain installation defined percentage P of transactions, e.g. P=90%, have ended. With P=90%, the lowest split bucket would be the 10th bucket in FIG. 7.

Alternatively the lowest split bucket is identified by a fix installation defined bucket number, e.g. the 20th bucket.

The identified split bucket is used to define a service class period duration for the split period and to create a new service class period in step 311. In other words, if nearly all transactions of the 27th and 28th bucket shall be associated with the new service class period, the average resource consumption of the 26th bucket is used as criteria for the switch, i.e. as service class period switch condition. In order to accomplish that all transactions of the buckets succeeding the split bucket are associated to the new service class period, a duration is assigned to the split service class period that limits the resource consumption to be not greater than the average resource consumption of a transaction that ended in the split bucket. If no transactions have ended in the split bucket, i.e. if this bucket is empty, the resource consumption of the split bucket is interpolated from the last non-empty bucket preceding the split bucket to the first non-empty bucket succeeding the split bucket. With this duration there will still be some few transactions ending in the last buckets of the first service class period, when transactions are delayed in the system for other reasons but not using resources at that time. Further on, some transactions which end in buckets preceding the split bucket (i.e. previous to the 27th bucket in FIG. 7 will potentially switch to the new service class period. These transactions are examples for short running but heavier resource consumers.

For the goal of the new created service class period a straight forward approach is applied. The overall objective is to minimize the impact of the long running transactions to other work in the system. Considering that the biggest impact is created for work at the same importance and at the next lower importance level, the most important parameter is the importance of the new period. For determining the importance of the new service class period the resource consumption of other work at the same and the lower importance levels is measured by the workload manager. Based on the amount of resources which is predicted for the new service class period, the workload manager 110 helps other work for which basically the same amount of resources are used by moving the new service class period to a lower importance level. Such work is moved to a lower importance level until the other work, which exhibits the same or nearly the same resource consumption, is provided with an equal or better access to resources.

As second criteria service class periods are observed which have been created by the mechanism described above from other service classes and workload manager 110 will not move a new service class period to a lower importance level than other service class periods of the same level which have been created from work of other service classes of the same importance level than the original service class period.

If the split service class period has a response time based goal, with the new service class period a response time based goal is associated which is set equal to the response time associated with the split bucket. If the split service class period has a throughput oriented goal, with the new service class period the same throughput oriented goal is associated, decreased by an installation defined factor.

The decision if the service consumption of a period is below target (step 320) can be reached as follows: If there is activity in the first service class period and if the number of ended transactions or the accumulated CPU consumption of the service class period falls below the installation defined target value, the service class period fulfills criterion 320 and is considered for deletion. If service class periods are deleted only if there is activity in the first service class period, it can be avoided that service class periods are deleted in times of low or no system contention. If the deleted service class period is succeeded by another service class period, the duration of the preceding service class period is set to the duration of the deleted service class period. If no succeeding service class period exists, the duration of the preceding service class period is deleted.

In a more sophisticated method a combined response time bucket distribution is used, which is generated by means of the workload manager 110 from the response time bucket distribution of the examined service class period and the preceding service class period.

For the combined response time distribution the method of identifying a split bucket (see above) is applied. If it is not possible to identify a split bucket, the service class period is considered for deletion. The prerequisite is, as for the simple method, that there is activity in the first service class period. The duration of the preceding service class period is updated as described for the simple method above.

### REFERENCE NUMERALS

1 first set of time buckets
2 second set of time buckets
10 time bucket
20 time bucket
40 bucket
41 first bucket
42 eight bucket
43 range
44 range
45 last bucket
100 computer system
101 operating system
110 workload manager
111 service definition
120 service class table
121 service class
122 service class period
123 service goal
124 response time
125 execution velocity
126 importance level
127 duration
128 sample and management data
130 goal management device
140 operating system resource
141 CPU resource
150 operating system user
151 subsystem
152 unit of work
160 data sampler
200 application
201 thread
211 internal representation
212 status data
223 status data bucket
224 response time distribution
300-330 method steps
400 distribution
500 time distribution
510 number of ended transactions
520 CPU consumption per transaction
700 chart
701 determined split bucket criterion
702 lowest split bucket criterion
703 direction of data analysis
704 direction of data analysis
710 accumulated CPU consumption
720 number of total ended transactions

1. A method of workload management in a computer system (100),
in which units of work (152) are organized into service classes (121), to which a certain amount of system resources (140) is provided, and
in which a number of service class periods (122) is associated to each service class (121),
characterized in that
the workload behavior within at least one present service class period (122) is determined, and
the number of available service class periods (122) is automatically adjusted based on the determined workload behavior.

2. The method as claimed in claim 1, wherein the characteristics of service class periods (122) is automatically adjusted based on the determined workload behavior.

3. The method as claimed in claim 1, wherein the step of determining the workload behavior comprises determining the transaction completion time and determining the resource consumption of a transaction.

4. The method as claimed in claim 1, wherein the step of adjusting the number of available service class periods (122) comprises automatically creating an additional service class period (122).

5. The method as claimed in claim 1, wherein the step of adjusting the number of available service class periods (122) comprises automatically deleting a present service class period (122).

6. A data processing program for execution in a computer comprising software code portions for performing a method according to anyone of the preceding claim 1 when said program is run on said computer.

7. A computer program product stored on a computer usable medium, comprising computer readable program means for causing a computer to perform a method according to claim 1 when said program is run on said computer.

8. A workload manager for a computer system,
in which units of work are organized into service classes to which a certain amount of system resources is provided, and
in which a number of service class periods is associated to each service class,
characterized in that it comprises
means for determining the workload behavior within a present service class period, and
means for automatically adjusting the number of available service class periods based on the determined workload behavior.
